(19) United States
(12) Patent Application Publication
(10) Pub. No.: US 2011/0179558 A1
(43) Pub. Date: Jul. 28, 2011

(54) Breathable Protective Fabric and Garment

(75) Inventor: Brian W. Lyons, Heath, TX (US)

(73) Assignee: INTERNATIONAL ENVIROGUARD SYSTEMS, INC., Mesquite, TX (US)

(21) Appl. No.: 12/845,211

(22) Filed: Jul. 28, 2010

Related U.S. Application Data
(60) Provisional application No. 61/229,472, filed on Jul. 29, 2009.

(51) Int. Cl. A62B 17/00; B01D 46/00

(52) U.S. Cl. 2/457; 55/486

(57) ABSTRACT

A breathable composite barrier fabric for protective garments includes a high strength nonwoven web, a barrier layer and an aperture film layer, with the barrier layer between the high strength nonwoven web and the film layer. The different layers and webs may be bonded together to form the fabric using calendaring, thermal bonding and/or adhesives. The breathable composite barrier fabric is capable of blocking particles as small as 0.3 microns at greater than 99% efficiency while allowing air transmissions between 7 CFM and 9 CFM at 20 Pa. Protective garments may be constructed using the breathable composite barrier fabrics so that the high strength nonwoven web is on the body side of the garment and the film layer is on the exterior of the garment.

### RELATED APPLICATIONS

This application claims the benefit of priority to U.S. Provisional Application No. 61/229,472 entitled “Breathable Protective Garment” filed Jul. 29, 2010, the entire contents of which are hereby incorporated by reference.

### BACKGROUND

Protective garments serve an important role in protecting workers from exposure to noxious materials in different industries. For example, protective garments are employed in chemical plants to protect workers from exposure to chemical agents, and in biological research labs for protecting researchers from exposure to bacteria or other infectious agents.

Currently available industrial protective garments fail to offer users a combination of optimal protection and comfort. For example, in garments that offer protection against noxious particles less than 0.5 micron, polyolefin and micro porous membrane material is used which sacrifices user comfort by blocking air transmission through the fabric. Additionally, garments that allow air transmission to provide user comfort fail to provide the adequate safety measures required to protect the user from noxious elements.

### SUMMARY

The various embodiments provide a breathable composite barrier fabric for protective garments which may include a high strength nonwoven web layer, a film layer, and a barrier layer positioned between the high strength nonwoven web and the film layer. The barrier layer may have a basis weight of 25 grams per square meter. The breathable composite fabric of the various embodiments can filter particles of 0.3 microns at greater than 99% efficiency.

The breathable composite barrier fabric of the various embodiments may demonstrate air transmission of between 7 cubic feet per minute (CFM) and 9 CFM at a pressure of 20 Pa. The breathable composite barrier fabric may be constructed so that the high strength nonwoven web layer is bonded to the barrier layer using adhesive bonding. The breathable composite barrier fabric may include a high strength nonwoven web layer which is a spunbond web having a basis weight of 30 grams per square meter. The barrier layer of the breathable composite fabric may include a meltblown web which is calendared and has a basis weight of 25 grams per square meter. The film layer of the breathable composite barrier fabric may be an aperture film to protect the fabric from abrasion and allow air permeation to eliminate the potential of heat stress on the user.

In an embodiment, protective garments may be made from the breathable composite barrier fabric.

### BRIEF DESCRIPTION OF THE DRAWINGS

The accompanying drawings, which are incorporated herein and constitute part of this specification, illustrate exemplary aspects of the invention, and together with the general description given above and the detailed description given below, serve to explain the features of the invention.

FIG. 1 is an exploded view of a breathable composite barrier fabric illustrating the three fabric layers according to an embodiment.

FIG. 2 is a cross-sectional view of a breathable composite barrier fabric illustrating how layers may be bonded together using adhesives.

FIG. 3 is a cross-sectional view of an embodiment breathable composite barrier fabric including an inner wicking layer.

FIG. 4 illustrates a garment made from the breathable composite barrier fabric according to an embodiment.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

As used herein, the terms “fiber” and “fibrous” mean a particulate material in which the length and diameter ratio of each material is greater than about 10.

The term “spunbond” filaments as used herein refers to filaments which are formed by extruding a molten thermoplastic material as filaments from a plurality of fine, usually circular, capillaries with the diameter of the extruded filaments then being rapidly reduced, for example, by fluid-drawing or other well known spunbond mechanisms. Spunbond filaments are generally continuous and usually have an average diameter of greater than about five microns.

The term “spunbond web” as used herein means a web formed from spunbond filaments. Spunbond nonwoven fabrics or webs are formed by laying spunbond filaments randomly on the collecting surface such as a foraminous screen or belt. Spunbond webs can be bonded by methods known in the art, such as hot-role calendaring, through air bonding, or by passing the web through a saturated-steam chamber at an elevated pressure. For example, the web can be thermally point bonded at a plurality of thermal bond points located across the spunbond fabric. An example production method for making spunbond nonwoven webs is disclosed in U.S. Pat. No. 4,340,563, the entire contents of which are hereby incorporated by reference.

The term “meltblown” fibers as used herein refers to fibers which are formed by extruding a melt-processable polymer through a plurality of capillaries as molten threads or filaments into a high velocity heated gas stream. A high velocity gas stream attenuates the filaments of molten thermoplastic polymer material to reduce their diameter to between about 0.5 and 10 microns. The meltblown fibers are generally discontinuous fibers but can also be continuous. The meltblown fibers carried by the high velocity gas stream may be deposited on a collecting surface to form a meltblown web of randomly dispersed fibers. The term “meltblown web” as used herein means a web formed of meltblown fibers. The meltblown process is well-known and is described in various patents and publications, including NRL Report 4364, “Manufacture of Super—Fine Organic Fibers” by V. A. Wendt, E. L. Boone, and C. D. Fluharty; NRL Report 5265, “An Improved Device for the Formation of Super Fine Thermoplastic Fibers” by K. D. Lawrence, R. T. Lukas, and J. A. Young; and U.S. Pat. No. 3,849,241, issued Nov. 19, 1974, the entire contents of all of which are hereby incorporated by reference.

The breathable composite barrier fabric of the various embodiments may include a high strength nonwoven web, a barrier layer and a film layer (e.g., aperture film). The high strength nonwoven web may provide a substantial portion of the strength and support to the barrier layer and the overall breathable composite barrier fabric. The barrier layer may provide a barrier fabric with a pore size which can filter out particles as small as 0.3 microns in size at greater than 99% efficiency. The film layer may provide protection to the breathable composite barrier fabric by preventing abrasions and allow air permeation for user comfort. Thus, the breathable composite barrier fabric may be used, for example, as a material to manufacture protective garments with the high strength nonwoven web facing the wearer and the film layer facing the environment. The high strength nonwoven web may be configured to have sufficient integrity and coherence to shield the barrier layer from abrasions such as may be caused by rubbing against the clothing or body of the person wearing the protective garment.

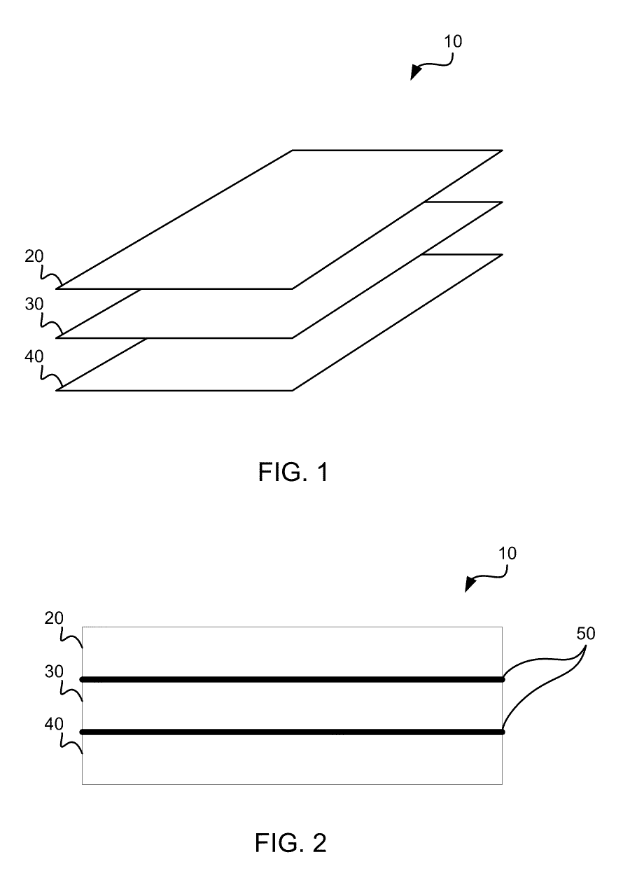

FIG. 1 illustrates an exemplary arrangement of the three layers of the breathable composite barrier fabric 10. The fabric may include at least three layers; a film layer 20, a barrier layer 30 and a high strength nonwoven web layer 40. The breathable composite barrier fabric 10 may be used in protective garments so the film layer 20 is the outer layer of the breathable composite barrier fabric to protect the inner layers from abrasion and to allow air permeation for user comfort.

The film layer 20 may be constructed from an aperture film. Such breathable films may be impervious to liquids when they are formed with microporous voids or openings sized that allow the transmission of water vapor but inhibit the transmission of liquids. Such films are well known and typically formed from a polyolefin film, such as polyethylene or polypropylene. Microporous breathable liquid impervious films are disclosed in U.S. Pat. No. 4,777,043; U.S. Pat. No. 5,855,999; and U.S. Pat. No. 6,309,736, the entire contents of all of which are hereby incorporated by reference. Breathable films having the requisite barrier properties are disclosed in U.S. Pat. No. 3,953,566 and U.S. Pat. No. 4,194,041, the entire contents of both of which are hereby incorporated by reference.

Positioned between the film layer 20 and the high strength nonwoven web layer 40 may be the barrier layer 30. The barrier layer 30 may be constructed from meltblown webs. The meltblown webs used in the various embodiments may have a basis weight between about 20 grams per square meter (GSM) to 30 GSM. Preferably, the barrier layer has a basis weight of about 25 GSM.

As the inner layer, the breathable composite barrier fabric 10 may include a high strength nonwoven web 40 to protect the barrier layer 30 and to provide strength to the overall fabric. The high strength nonwoven web layer 40 may be composed of material having high strength and abrasion resistance and which are capable of being attached to the other layers (e.g., the film layer 20). The high strength nonwoven web layer 40 may be a spunbond nonwoven web with the desired strengthen and abrasion characteristics. In an embodiment, the spunbond web may have a basis weight of about 25 GSM to about 35 GSM, and more preferably about 30 GSM.

Because spunbond fibers are generally not tacky when laid on a surface to form a web, it may be necessary to impart additional integrity to the web by one or more means known in the art such as, by point bonding, through-air bonding, HAK (hot air knife), Hydroentangling, needle punching and/or adhesive bonding.

The high strength nonwoven web layer 40, barrier layer 30 and film layer 20 collectively make up the breathable composite barrier fabric 10. Although the various embodiments primarily discuss the use of three layers it would be appreciated by those skilled in the art that additional layers and/or internal layers may be used in connection with the breathable composite barrier fabrics 10.

In an embodiment, the high strength nonwoven web layer 40 or the barrier layer 30 may be calendared as part of the processing before it is laminated into a fabric.

The layers and webs of the fabric of the various embodiments may be bonded to one another using different techniques. In an embodiment, the layers and webs of fabric may be bonded using a calendaring process. For example, the high strength nonwoven web layer 40 and the barrier layer 30 may be bonded together by calendaring. A combination of some calendar and some un-calendared fabrics may also be used in various embodiments.

In a further embodiment, different layers and webs of fabric may be bonded together using techniques such as thermal bonding. While the breathable composition barrier fabric may be made from a variety of materials, the different layers and webs used to construct the fabric may include some polyolefin materials with similar melting points. For example, the barrier layer 30 and the film layer 20 may include polyethylene or polypropylene Likewise the high strength nonwoven web layer 40 may also include fibers or fiber components made from polyethylene or polypropylene. Having similar materials in all three layers allows for thermal bonding of the different layers and webs when forming the fabrics of the various embodiments.

In an embodiment illustrated in FIG. 2, the different layers and webs may be bonded together using adhesives 50, such as commercially available adhesives. A suitable commercial adhesive is sold by the National Starch & Chemical Co. Ltd. under the Product No. DM5213. Such inter-layer adhesives may possess a basis weight of 2-3 GSM. In an embodiment, the fabrics of the various embodiments may be fabricated using adhesive lamination, as well as other methods known in the art.

In an embodiment, known UV stabilizers may be added to the layers of fabric. Examples of such stabilizers include 2-hydroxybenzophenones; 2-hydroxybenzotriazoles; hydroxybenzoates; metal chelate stabilizers; and hindered amine light stabilizers. An example of hydroxybenzoate stabilizers is 2,4-di-t-butylphenyl ester which is described in U.S. Pat. No. 3,206,431, the entire contents of which is hereby incorporated by reference. Metal chelate stabilizers are also known in the art and primarily include nickel complexes. Preferably, stabilizers used in the various embodiments are hindered amine light stabilizers, which is a class of stabilizers including a cyclic amine moiety having no hydrogen atoms adjacent to the nitrogen atom.

Hindered amines and amines may also be used as UV stabilizers and are disclosed in U.S. Pat. No. 5,200,443, the entire contents of which is hereby incorporated by reference. It should be noted that hindered amine stabilizers having molecular weights above 1000, preferably between about 1000 and 5000, typically provide improved stabilization as compared to similar lower molecular weight stabilizers. Preferably, the amount of hindered amine within the polymeric composition may be between about 0.5% and about 3% by weight. However, the manner and amount of UV stabilizer added to the polymeric compositions will naturally vary with the particular polymer formulation and UV stabilizer selected.

In a further embodiment, pigments may be added to the layers in order to improve UV stability and/or to improve aesthetics of the resulting products. Because even simple organic pigments may have adverse affects on UV stability, pigments which further enhance UV stability such as, metal oxide pigments in conjunction with hindered amine stabilizers, may be used. Using pigments in conjunction with UV stabilizers is disclosed in U.S. Pat. Nos. 5,200,443, 6,040,255, and 5,738,745, the entire contents of all of which are hereby incorporated by reference.

The breathable composite barrier fabric 10 of the various embodiments may be configured so that it can capture particles as small as 0.3 micron by methods such as inertial deposition, random diffusion and electrostatic deposition in addition to physical interception. This protection may be accompanied with copious air circulation and air transfer through the composite barrier fabric. Air transmission of the fabrics of the various embodiments range between 7 and 9 cubic feet per meter (CFM) at a differential pressure of 20 Pascal (Pa), as measured according to test method ASTM D737. The ASTM D737 test method is well known and measures the air permeability of textile fabrics, including woven fabrics, airbag fabrics, blankets, napped fabrics, knitted fabrics, layered fabrics, piled fabrics. Air permeability means the rate of airflow passing perpendicularly through a known area under a prescribed air pressure differential between the two surfaces of a material.

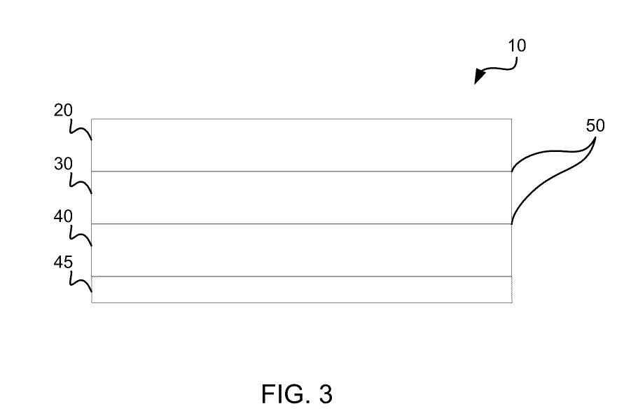

The breathable composite barrier fabric 10 of the various embodiments is light weight, typically in the range of equal to or less than about 50 GSM. The breathable composite barrier fabric 10 of the various embodiments may be constructed to be capable of wicking sweat away from the skin surface of a user by hydrophobic and/or hydrophilic filaments or inner coating. This embodiment is illustrated in FIG. 3, which shows an inner coating layer 45 fabricated from hydrophobic and/or hydrophilic filaments. The inner coating layer 45 may be bonded to the high strength nonwoven web layer 40 by any method known in the art. The breathable composition barrier fabric of the various embodiments may also allow reproducibility and easy manufacturing of the filtration rating.

The strength of the fabrics of the various embodiments may be evaluated using the ASTM D5036 test method. Using this method, the strength of an embodiment fabric has been measured to be about 7.5 lbs machine direction (MD) by 8.1 lbs cross direction (CD). Another test that may be used to measure the strength of a fabric is ASTM D5735. Using the ASTM D5735 test, the strength of an embodiment fabric has been measured to be about 2.5 lbs MD by 2.5 lbs CD.

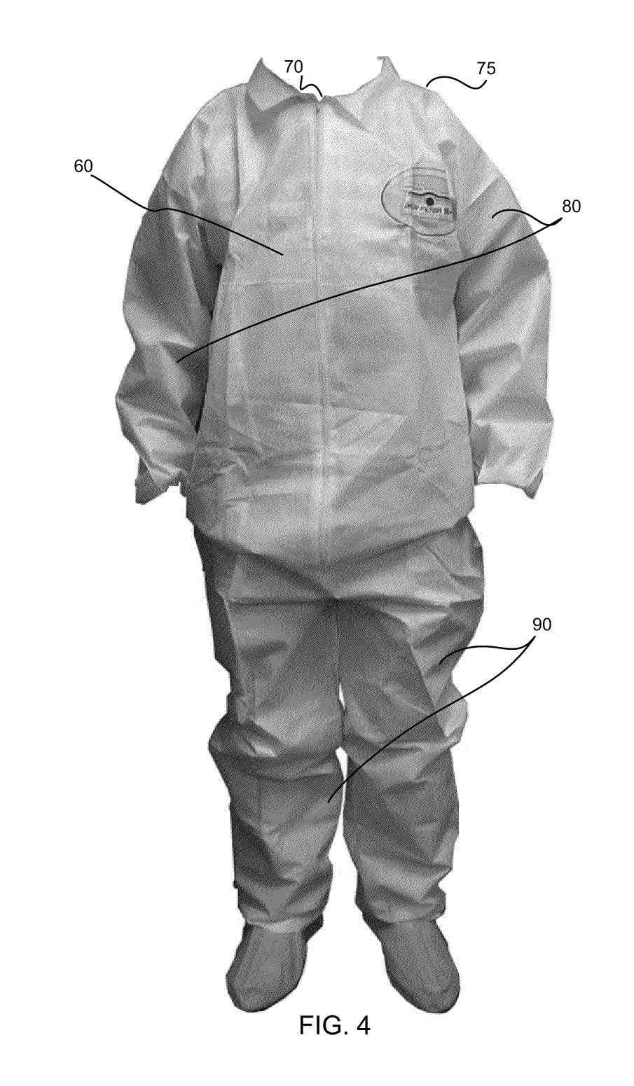

The fabrics of the various embodiments may be used to make protective garments. FIG. 4 illustrates an embodiment protective garment made from an embodiment breathable composite barrier fabric. The protective garment may include a body portion 60 having a neck opening 70 in the shoulder line 75 at its top, two sleeves portions 80 extending from the body portion 60, each sleeve portion having an inner edge and an outer edge, and two leg portions 90 extending from the body portion 60.

In a further embodiment, the fabrics of the various embodiments may be used to make garments which are in the form of coveralls with and without hoods and booties, aprons, lab coats, shoe and booty covers, and clean-room garments. Because the fabrics of the various embodiments filter particles as small as 0.3 micron and allow copious air transmission through the fabric layers and webs, garments constructed from such fabrics provide safe and comfortable apparels for users.

While the invention has been described in detail with respect to specific embodiments thereof, it will be apparent to those skilled in the art that various alterations, modifications and other changes may be made without departing from the scope of the embodiments described herein. It is therefore intended that all such modifications, alterations and other changes be encompassed by the claims. Further, any reference to claim elements in the singular, for example, using the articles “a,” “an” or “the” is not to be construed as limiting the element to the singular.

What is claimed is:

1. A breathable composite barrier fabric for protective garments, comprising:
a high strength nonwoven web layer;
a film layer; and
a barrier layer positioned between the high strength nonwoven web layer and the film layer, the barrier layer having a basis weight of 25 grams per square meter;
wherein the breathable composite barrier fabric can filter particles of 0.3 microns at greater than 99% efficiency.

2. The breathable composite barrier fabric of claim 1, wherein the fabric is configured to allow air transmission of between 7 cubic feet per minute (CFM) and 9 CFM at a differential pressure of 20 Pa.

3. The breathable composite barrier fabric of claim 1, wherein the high strength nonwoven web layer is bonded to the barrier layer using adhesive bonding.

4. The breathable composite barrier fabric of claim 1, wherein the high strength nonwoven web layer is a spunbond web having a basis weight of 30 grams per square meter.

5. The breathable composite barrier fabric of claim 1, wherein the barrier layer is a meltblown web which is calendared, the meltblown web having a basis weight of 25 grams per square meter.

6. The breathable composite barrier fabric of claim 1, wherein the film layer is an aperture film to eliminate the potential of heat stress on the user.

7. The breathable composite barrier fabric of claim 1, wherein one or more of the high strength nonwoven web layer, barrier layer and film layer include a UV.

8. The breathable composite barrier fabric of claim 1, further comprising an inner coating layer configured to wick sweat away from a user's skin.

9. A protective garment, comprising:
a body portion having a neck opening in the shoulder line at its top;
two sleeves portions extending from the body portion, each sleeve portion having an inner edge and an outer edge; and
two leg portions extending from the body portion,
wherein the portions of the protective garment are made from a breathable composite barrier fabric, comprising:
a high strength nonwoven web layer;
a film layer; and
a barrier layer positioned between the high strength nonwoven web layer and the film layer, the barrier layer having a basis weight of 25 grams per square meter;
wherein the breathable composite barrier fabric can filter particles of 0.3 microns at greater than 99% efficiency.

10. The protective garment of claim 9, wherein the fabric is configured to allow air transmission of between 7 cubic feet per minute (CFM) and 9 CFM at a differential pressure of 20 Pa.

11. The protective garment of claim 9, wherein the high strength nonwoven web layer is bonded to the barrier layer using adhesive bonding.

12. The protective garment of claim 9, wherein the high strength nonwoven web layer is a spunbond web having a basis weight of 30 grams per square meter.

13. The protective garment of claim 9, wherein the barrier layer is a meltblown web which is calendared, the meltblown web having a basis weight of 25 grams per square meter.

14. The protective garment of claim 9, wherein the film layer is an aperture film to eliminate the potential of heat stress on the user.

15. The protective garment of claim 9, wherein one or more of the high strength nonwoven web layer, barrier layer and film layer include a UV.

16. The protective garment of claim 1, further comprising an inner coating configured to wick sweat away from a user's skin.
